(19) United States
(12) Patent Application Publication
(10) Pub. No.: US 2003/0137754 A1
(43) Pub. Date: Jul. 24, 2003

(54) Multistage system for radiant energy flux transformation

(76) Inventors: Sergiy Victorovich Vasylyev, Davis, CA (US); Viktor Petrovych Vasylyev, Kharkiv (UA)

Correspondence Address: SERGIY V. VASYLYEV, 1311 LAKE BLVD., DAVIS, CA, 95616, US

(21) Appl. No.: 10/339,123

(22) Filed: Jan. 9, 2003

Related U.S. Application Data
(63) Continuation-in-part of application No. 10/026,121, filed on Dec. 17, 2001.
(60) Provisional application No. 60/347,603, filed on Jan. 9, 2002.

(51) Int. Cl. G02B 5/10

(52) U.S. Cl. 359/853

(57) ABSTRACT

A radiant energy flux transformation system including a primary linear focus concentrating collector formed by a plurality of cylindrical slat-like reflectors and a secondary elongated collector is described. The reflectors of primary collector generally have concave or planar transversal profiles and are positioned in a stepped arrangement with longitudinal axes being parallel to each other and to the secondary collector. The reflectors are tilted away from the direction to the source of radiant energy at a range of angles being less than 45° to reflect and direct the incident energy flux to a common focal region located below the primary collector where the concentrated flux is intercepted and further transformed by the secondary collector. In addition to efficient concentrating radiant energy such as sunlight, the system can provide uniformity or a desired energy distribution in the concentrated flux.

### CROSS-REFERENCE TO RELATED APPLICATIONS

This application is a continuation-in-part of application Ser. No. 10/026,121 filed Dec. 17, 2001. This application also claims the benefit of prior U.S. Provisional Patent Application Serial No. 60/347,603 filed Jan. 9, 2002.

### BACKGROUND OF THE INVENTION

1. Field of the Invention

The present invention relates to a device for concentrating and transforming radiant energy with a multistage energy flux transformation system. In particular, this invention relates to linear focus solar energy concentrators.

2. Description of Prior Art

It is well known that cylindrical parabolic mirrors and Fresnel lenses are used to concentrate the solar radiation which intensity is otherwise fairly low at the ground level for its direct use. While parabolic mirrors are notably superior in concentration over the lenses, this prior art design concept has the limitation of requiring tight shape and alignment tolerances to keep the concentrated sunlight focused onto a narrow target area. On the other hand, there is a limitation of energy collection ability of one-stage energy concentrators related to finite angle (one half degree) the sun subtends. As a result, the concentrated beam projected on the target has poorly defined boundaries because they are formed by the rays mainly emanated from the edge portions of the solar disk. These outer rays also have a longer path length giving rise to a larger transversal spread of the focal line.

Various arrangements have been proposed in the past for improving the sunlight collection of linear focus devices by introducing secondary optics into the concentrated beam reflected from the primary parabolic mirror. One of the major problems of such past proposals is the inherent problem of partial shadowing the primary concentrator by the secondary and relative inaccessibility of the focal line which hampers the utility of the devices.

The known multi-reflection systems, such as those derived from Cassegrain telescope optics, have a further drawback that the entire flux reflected by the primary mirror is entirely redirected back by the secondary mirror resulting in a longer path of concentrated flux and decreased concentration efficiency.

None of these previous efforts provides the benefits attendant with the present invention. The present invention achieves its intended purposes, objects and advantages over the prior art devices through a new, useful and unobvious combination of component elements and operation, at a reasonable cost to manufacture, and by employing only readily available materials.

It is an object of this invention to provide an improved radiant energy flux transformation system which increases the concentration of incident flux impinging on the primary reflector structure without disposing the secondary collector in the path of incident flux.

Another object of this invention is to provide an improved radiant energy flux transformation system which provides improved focusing for off-axis rays with minimum reflections and minimizes energy losses.

It is yet another object of the present invention to provide a system for radiant energy flux transformation which is composed by relatively simple optical elements and which is of compact and sturdy construction.

A further object is to provide an efficient reflective energy collecting system capable of substantially uniformly distributing the concentrated flux over a receiver surface.

Other objects and advantages of this invention will be apparent to those skilled in the art from the following disclosure and appended claims.

### BRIEF SUMMARY OF THE INVENTION

In accordance with the present invention, the prior art problems are solved by a multistage system for radiant energy flux transformation comprising a primary concentrating collector being a rear-focus reflector structure and an elongated secondary collector. The primary collector is formed by an array of slat-like reflective surfaces having longitudinal axes extending parallel to each other and reflecting the incident energy to a plurality of converging directions to form a common linear focal area. Each reflective surface is tilted away from the direction to the energy source at an angle preferably less than 45° so that the incident flux is reflected from it at an angle being greater than 45° and not greater than 90° to provide a rear disposition of the focal area formed by the primary collector. The secondary collector is disposed in energy receiving relation with at least one of reflective surfaces of the primary collector to intercept and redirect at least a part of radiant energy flux reflected from the primary collector so that the efficiency of desired flux transformation is increased.

According to one aspect of the invention, in a preferred embodiment, there is provided a multistage system for radiant energy flux transformation in which reflective surfaces of the primary collector are designed and positioned to minimize screening and shadowing on other reflective surfaces. The primary collector can incorporate two symmetric segments facing toward each other.

According to another aspect of the invention, when it is applied to transforming and utilizing solar energy, the focal line of concentrated sun rays is situated below the primary reflector structure with the advantageous result that the secondary concentrating collector can be disposed in a close proximity to said focal line without shadowing the primary collector and without associated energy loss. The multistage system for radiant energy flux transformation can further incorporate a photovoltaic receiver.

According to yet another aspect of the invention there is provided a multistage system for radiant energy flux transformation in which reflective surfaces have concave profiles represented by simple or compound segments of parabolic or circular shape.

According to a further aspect of the invention there is provided a multistage system for radiant energy flux transformation in which the energy secondary collector can be mechanically separated from the primary collector. Furthermore, one or more reflective surfaces of the primary collector can be disposed in any one of a translated, a reversed and/or a rotated orientation relative to the others having the same basic arrangement.

According to a yet further aspect of the invention there is provided a multistage system for radiant energy flux transformation in which one or more reflective surfaces of the primary collector can be disposed in any one of a translated, a reversed and/or a rotated orientation relative to the others having the same basic arrangement.

### DRAWING FIGURES

FIG. 1 is a perspective view of a multistage system for radiant energy flux transformation in accordance with a preferred embodiment of the present invention;

FIG. 2 is a perspective schematic view of an embodiment of the invention further comprising a photovoltaic receiver and a heat sink;

FIG. 3 is a schematic orthogonal view of the system shown in FIG. 2;

FIG. 4 is a schematic orthogonal view of a further embodiment of the invention employing flux homogenizer as a secondary collector;

FIGS. 5 and 6 are schematic perspective views of further embodiments of the invention employing different types of radiant energy concentrators as a secondary collector;

FIG. 7 is a schematic orthogonal view of a further embodiment of the multistage radiant energy flux transformation system.

### DESCRIPTION OF THE PREFERRED EMBODIMENTS

The embodiments of flux transformation systems selected for the purpose of illustrating the invention include a primary rear-focus concentrating flux collector and an elongated secondary flux collector.

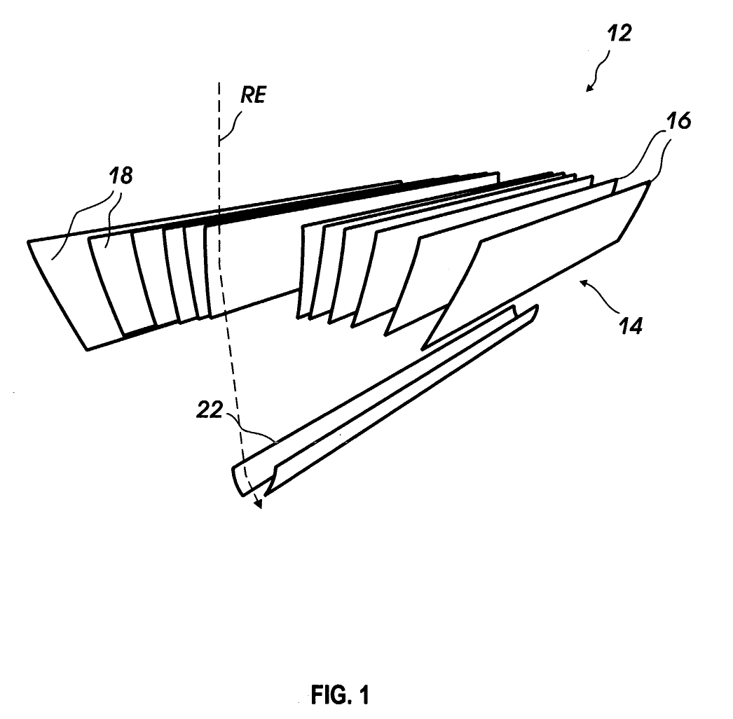

FIG. 1 shows a perspective schematic view of a system 12 for concentrating and transforming radiant energy flux according to a preferred embodiment. System 12 includes a primary concentrating collector 14 comprising an array of cylindrical elongated reflectors 16 with longitudinal axes generally aligned parallel to a reference line (not shown), and an elongated secondary concentrating collector 22 extending parallel to reflectors 16. The array of reflectors 16 comprises two symmetric segments where reflectors 16 are spaced apart and positioned adjacent to each other.

Reflectors 16 are individually tilted and aligned in a stepped arrangement, so that primary collector 14 has a linear Venetian blind-like configuration. Reflectors 16 have mirrored surfaces 18 having concave transversal profiles which individual curvatures are selected to concentrate and reflect radiant energy onto a linear focus area.

In order to entirely utilize the radiant energy received by the primary collector aperture, adjacent reflectors 16 can be appropriately spaced relatively to each other so that all incident radiation is intercepted. Additionally, reflectors 16 can be arranged one with regard to the adjacent one in such a manner that the energy portions reflected by one reflector are not intercepted by the adjacent reflector.

It is important, according to the invention, that each reflector 16 is tilted away from the direction to the energy source at an angle preferably less than 45°. It will be appreciated by those skilled in the art that, as a matter of geometry, the angles of incidence and, consequently, the angles of reflection of radiant energy impinging on surfaces 18 will be greater than 45° and not greater than 90° thus providing the rear disposition of the focal area formed by primary collector 14. Furthermore, according to a preferred embodiment, reflectors 16 can be positioned at successively increasing distances from and at successively increasing angles to the plane of symmetry of primary collector.

Secondary collector 22 should be disposed in energy receiving relation with at least one of mirrored surfaces 18 of primary collector 14 and located relatively remote from surfaces 18. According to a preferred embodiment, secondary collector 22 can be a line-focus energy collector of a known type. By way of example, as shown in FIG. 1, secondary collector 22 can include a non-imaging solar energy concentrator composed by two curved trough mirrors symmetrically disposed and facing toward each other.

Reflectors 16 can easily be fabricated using a number of means and materials. For example, reflectors 16 can be made of metal through extrusion of a metal part, roll-forming, slip rolling from sheet material, pressing, moulding, machining, or electroforming, and then polished on the reflecting side to obtain the required specular reflectivity for surfaces 18. In an alternative example, plastic compound materials can be used for fabricating elements 16 and a foil or nonmetal aluminized or silvered film can be used as a reflective material for mirrored surfaces 18.

Multistage system 12 for radiant energy flux transformation forming the object matter of this invention can be based on a primary concentrating collector 14 comprising a number of reflectors 16 having individual parabolic transversal profiles and dimensions to obtain improved concentration of radiant energy. In view of that the construction of parabolic profiles can be relatively difficult, we propose a slight modification of collector 14 employing circular profiles for reflectors 16 or profiles formed by simple or a combination of two or more planar segments. Moreover, according to a further modification, reflectors 16 can be constructed with identical circular shapes and dimensions thus greatly simplifying the manufacturing process and enabling batch fabrication.

Reflectors 16 and secondary collector 22 can be interconnected or mounted to a frame in any suitable manner. For example, a frame may be provided which comprises walls (not shown) of metal, plastic, wood or other material extending transversely of the reflective element longitudinal axes at the reflector ends to support both primary and secondary collectors. Suitable tubular frame members (also not shown) may interconnect the walls to form a rigid structure.

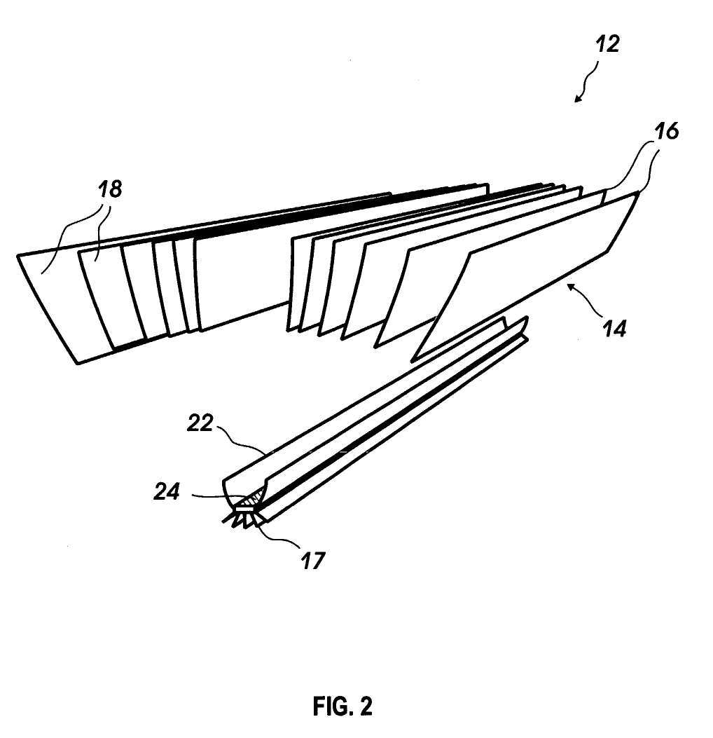

System 12 can further comprise a receiver for receiving and converting the concentrated energy flux to whatever useful type of energy. For example, as shown in FIG. 2, a narrow-strip photovoltaic panel 24 can be provided for converting solar energy to electricity. Panel 24 can further include a heat sink 17 for heat extraction. Panel 24 can also be disposed in thermal relation to secondary collector 22 for improved heat dissipation.

System 12 can further incorporate a tracking device operatively connected to the primary and secondary collectors to follow the movement of the source of radiant energy. The tracking device may include mechanical, hydraulic, electric and electronic components such as are well-known in the art. By way of example, if system 12 is used to concentrate and utilize solar energy, a one-axis tracker can be employed with orienting the longitudinal axes of primary and secondary collectors in South-North direction and East-West tracking the movement of the sun.

In operation, when system 12 is used to collect and transform solar energy, incident radiant energy RE strikes mirrored surfaces 18 of primary collector 14. Surfaces 18 concentrate radiant energy RE and reflect the energy towards secondary collector 22. Radiant energy RE is further reflected from secondary collector 22 and concentrated onto a smaller focal area.

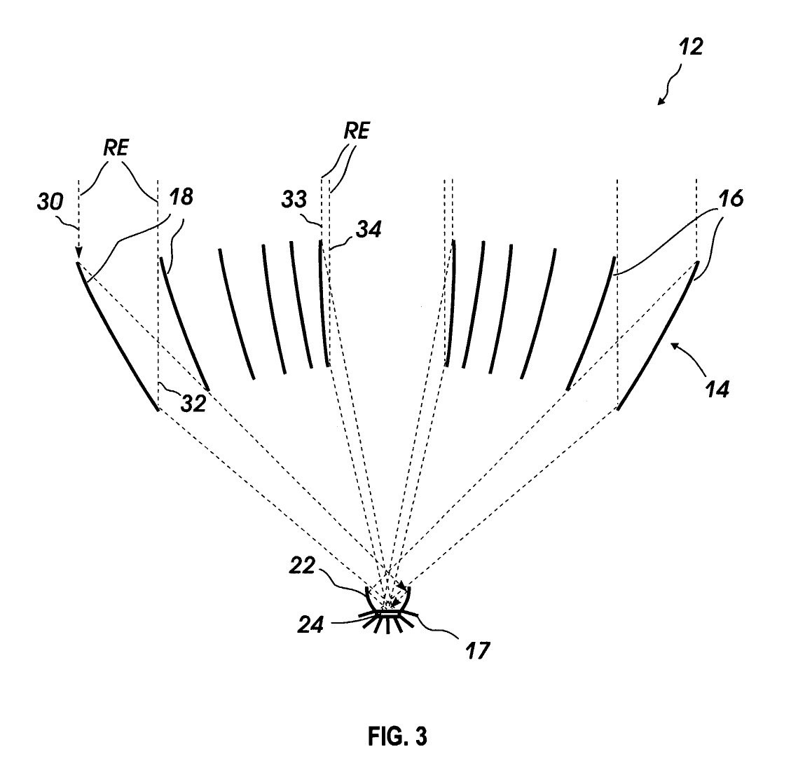

FIG. 3 more fully illustrates operation of the system shown in FIG. 2 when it is applied to transforming and utilizing solar energy. Referring to FIG. 3, incident rays 31, 32, and 33 of sunlight RE strike surfaces 18 of reflectors 16 arranged so that these rays are reflected from surfaces 18 and focused on the target area of receiving panel 24 using a single reflection. Incident ray 30, which can be an off-axis ray emanated by a peripheral zone of the solar disk and/or a ray impinging on an edge zone of surface 18, is reflected from surface 18 to a proximity of focal area of primary collector 14 where ray 30 is intercepted by secondary collector 22 and redirected to panel 24 so that no energy is lost and net concentration is improved. In other words, energy portions reflected from the respective surfaces 18 of primary collector 14 are focused and at least partially intercepted by secondary collector 22. Secondary collector 22 transforms the energy flux cooperatively formed by surfaces 18 so that the concentrated energy flux projected on target panel 24 will have a smaller transversal spread and sharply defined boundaries and radiant energy will be further intensified. It will be appreciated that secondary collector 22 can be designed to intercept and redirect only peripheral parts of the concentrated flux formed by primary collector 14 with the result of an improved concentration using minimum reflections and thus minimizing energy loss.

Other Embodiments

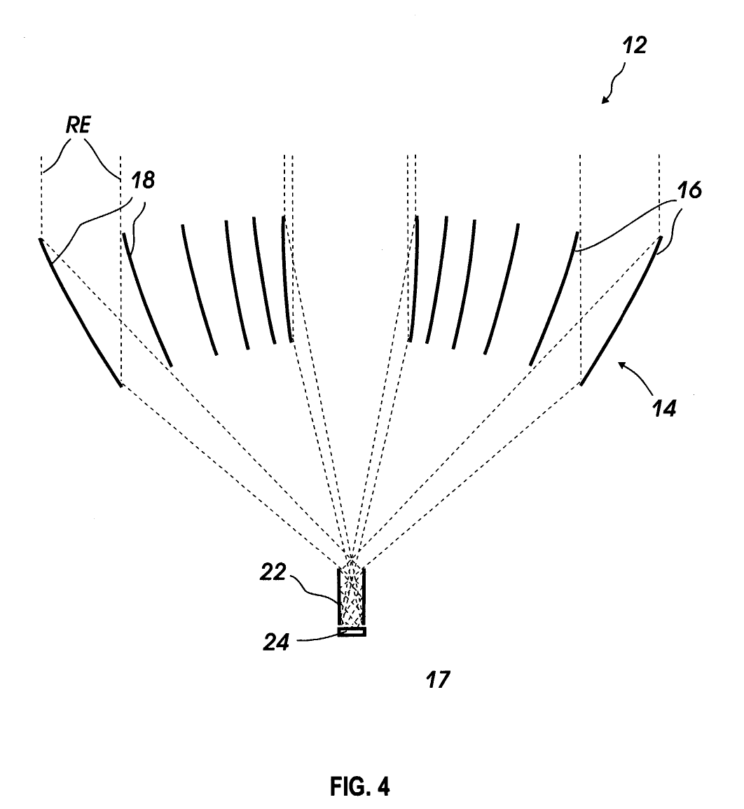

FIGS. 4 through 7 show other embodiments of the invention.

FIG. 4 shows a schematic orthogonal view of system 12 where secondary collector 22 comprises two reflective walls of planar shape to provide homogenization of the energy flux concentrated by primary collector 14. This can be useful, for example, for improving the performance of panel 24.

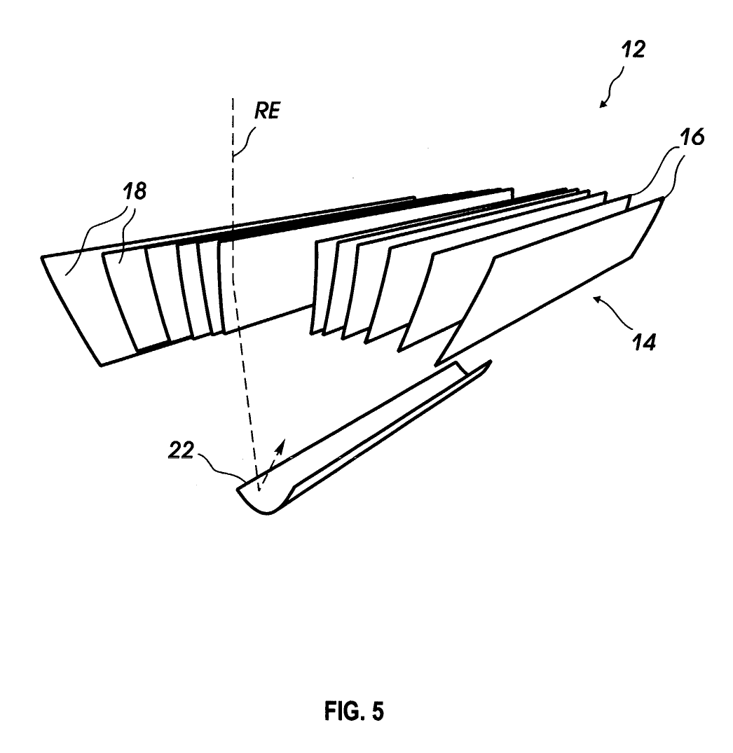

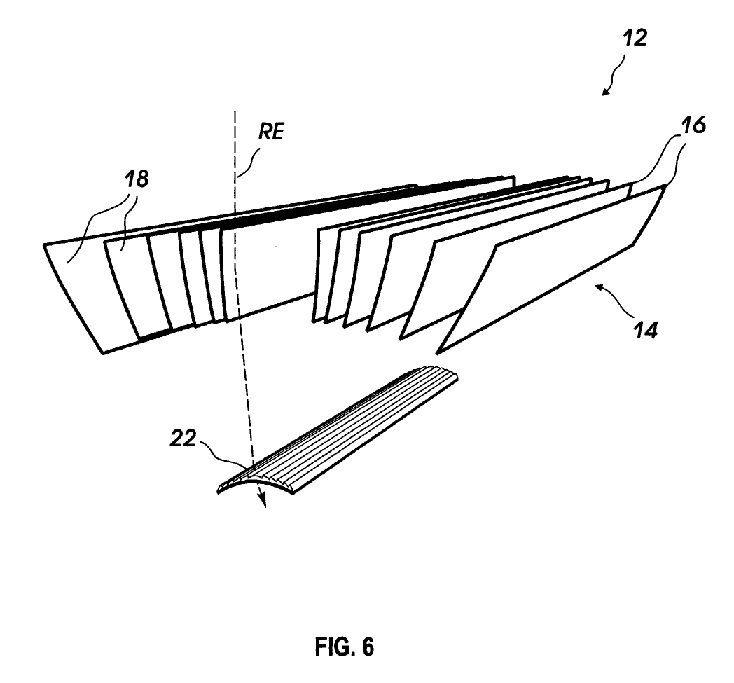

When system 12 is used to collect and convert solar energy, secondary collector 22 can be an imaging linear solar concentrator of a know type. FIGS. 5 and 6 show respectively a reflective parabolic trough and a refractive Fresnel lens used as secondary collector 22.

The foregoing embodiments are described upon the case when reflectors 16 have fixed positions relatively to each other. However, this invention is not only limited to this, but can be applied to the case where reflectors 16 can be rotated around their longitudinal axes and/or moved relatively to each other and secondary collector 22. Alternatively, secondary collector 22 can be moved and/or rotated, for example, to intercept different portions of the concentrated energy flux reflected from reflectors 16 of primary collector 14.

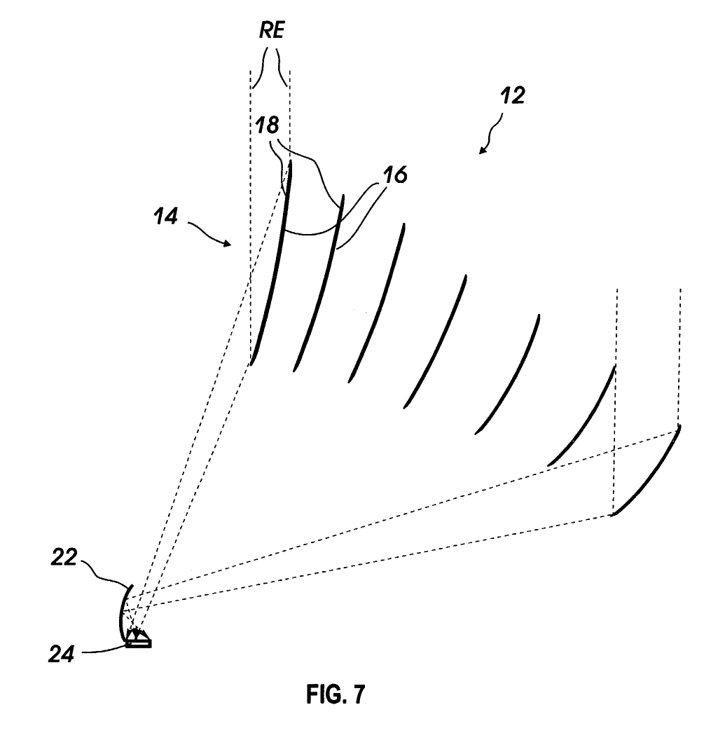

The foregoing embodiments are also described upon the case when the array of elements 16 of primary collector 14 comprises two symmetric segments disposed at an angle to each other. However, this invention is not only limited to this, but can be applied to the case where only one segment is used (asymmetric design), for example, as illustrated in FIG. 7. Secondary collector can be a parabolic trough or planar rectangular mirror which can intercept at least a part of concentrated energy flux reflected from uttermost reflectors 16, for example, to provide a desired flux convergence or normal energy flux incidence onto panel 24.

Alternatively, reflectors 16 can be organized in two or more arrays that can be tilted, rotated, and positioned differently relatively to each other and secondary collector 22.

There are also various other possibilities with regard to the dimensions, number and relative disposition of reflectors 16, as well as individual curvatures of surfaces 18. In addition, one or more individual reflectors 16 can be selectively added, omitted, changed or replaced in primary collector 14 to provide a desired operation. Dimensions, curvatures and relative dispositions of reflectors 16 can be varied so that the concentrated beams reflected from respective surfaces 18 can be made partially overlapped, contacting, or spaced apart. It will be appreciated that primary collector 14 and secondary collector 22 can be designed so that the energy distribution profile in the focal line will be tailored to a desired shape

Although the above description contains many specificities, these should not be construed as limiting the scope of the invention but are merely providing illustrations of some of the presently preferred embodiments of this invention. While a variety of embodiments have been disclosed, it will be readily apparent to those skilled in the art that numerous modifications and variations not mentioned above can still be made without departing from the spirit and scope of the invention.

What is claimed is:

1. A multistage system for radiant energy flux transformation comprising:
a primary energy collector comprising a plurality of spaced apart elongated reflective surfaces oriented with the longitudinal dimensions generally parallel to a reference line, said surfaces being inclined at predetermined angles to direct parallel rays toward a plurality of converging directions, said angles being such as to result in the reflection of said parallel rays at a range of angles of incidence having particular values more than 45° and less than 90°; and
an elongated secondary energy collector extending parallel to said reference line and disposed in energy receiving relation to at least one of said surfaces
wherein at least a portion of radiant energy flux impinging on and reflected from said surfaces of said primary energy collector is intercepted and redirected by said secondary energy collector.

2. The multistage system of claim 1 wherein said surfaces are designed and positioned to minimize screening and shadowing on other said surfaces.

3. The multistage system of claim 1 wherein said surfaces are mirrored strips of rectangular planar shape.

4. The multistage system of claim 3 wherein said strips are made of sheet metal material.

5. The multistage system of claim 1 wherein at least one of said surfaces has concave parabolic transversal profile.

6. The multistage system of claim 1 wherein at least one of said surfaces has concave circular transversal profile.

7. The multistage system of claim 6 wherein said at least one of said surfaces comprises a plate of cylindrical shape formed from sheet metal material to a predetermined radius of curvature.

8. The multistage system according to claim 1 and wherein said surfaces are of identical dimensions.

9. The multistage system as defined in claim 1 wherein said a primary energy collector is formed by two symmetrical segments.

10. The multistage system of claim 1 wherein said secondary energy collector is mechanically separated from said primary energy collector.

11. The multistage system of claim 1 wherein said secondary energy collector comprises means for flux homogenization

12. The multistage system of claim 1 wherein said secondary energy collector is a non-imaging linear focus solar energy concentrator.

13. The multistage system of claim 1 wherein said secondary energy collector is a linear focus Fresnel lens.

14. The multistage system of claim 1 wherein said secondary energy collector is a planar rectangular mirror.

15. The multistage system of claim 1 wherein said secondary energy collector is a parabolic trough.

16. The multistage system of claim 1 further comprising at least one tracking means for tracking the source of said radiant energy flux.

17. The multistage system of claim 1 wherein one or more said mirrored surfaces is disposed in any one of a translated, a reversed and/or a rotated orientation relative to the others having the same basic arrangement.

18. A solar energy collector employing the combination of a primary optical concentrator comprising a plurality of elongated reflectors positioned to reflect and direct sunlight downward to a linear focus area, at least one secondary optical element, and at least one photovoltaic solar cell wherein said at least one secondary optical element is positioned to redirect at least a portion of the focused sunlight to said at least one photovoltaic solar cell;

19. The solar energy collector of claim 18 wherein said reflectors are line focusing cylindrical troughs;

20. The solar energy collector of claim 18 wherein said reflectors are rectangular planar strips of a reflective sheet material.
